(19) United States
(12) Patent Application Publication
(10) Pub. No.: US 2015/0189401 A1
(43) Pub. Date: Jul. 2, 2015

(54) ADVERTISEMENT SCHEME

(71) Applicant: KT Corporation, Seongnam-si (KR)

(72) Inventors: Donghoon YI, Gyeonggi-do (KR); Hak-gyun ROH, Cheonan-si (KR); Yeong-il SEO, Seoul (KR)

(21) Appl. No.: 14/582,315

(22) Filed: Dec. 24, 2014

(30) Foreign Application Priority Data
Dec. 31, 2013 (KR) 10-2013-0168730

(51) Int. Cl. H04N 21/845; H04N 21/435; H04N 21/235; H04N 21/454; H04N 21/4545; H04N 21/472; H04N 21/242; H04N 21/43; H04N 21/8547; H04N 21/6587; H04N 7/173; H04N 21/81; H04N 21/234

(52) U.S. Cl. CPC H04N 21/8456; H04N 21/812; H04N 21/435; H04N 21/235; H04N 21/4542; H04N 21/45457; H04N 21/23424; H04N 21/242; H04N 21/4307; H04N 21/8547; H04N 21/6587; H04N 7/17336; H04N 7/17318; H04N 21/47202

(57) ABSTRACT

In one example embodiment, a method performed under control of a server include dividing video content into a plurality of video segments; receiving, from a first content player, a request to stream the video content; receiving segment playing information from a second content player; generating an advertisement and playing information regarding the advertisement based on the segment playing information; selecting at least one of the plurality of video segments based on the segment playing information; generating play sequence information based on the playing information regarding the advertisement and the at least one of the plurality of video segments; transmitting, to the first content player, the generated play sequence information, the advertisement, and the plurality of video segments; and synchronizing the plurality of video segments for playing on the first content player with the plurality of video segments for playing on the second content player.

### TECHNICAL FIELD

The embodiments described herein pertain generally to an advertisement scheme.

### BACKGROUND

Traditionally, media content provider head-ends may provide advertisements to subscribing media playing devices while the media playing device is not in use. For instance, programming menus and advertisements may be downloaded at times of the day when a user would typically not be viewing any media content, e.g., 03:00 a.m.

### SUMMARY

In one example embodiment, a method performed under control of a server may include: dividing video content into a plurality of video segments; receiving, from a first content player, a request to stream the video content; receiving segment playing information from a second content player; generating an advertisement and playing information regarding the advertisement based on the segment playing information; selecting at least one of the plurality of video segments based on the segment playing information; generating play sequence information based on the playing information regarding the advertisement and the at least one of the plurality of video segments; transmitting, to the first content player, the generated play sequence information, the advertisement, and the at least one of the plurality of video segments; and synchronizing the at least one of the plurality of video segments for playing on the first content player with the at least one of the plurality of video segments for playing on the second content player.

In another example embodiment, a server may comprise: a video segment divider configured to divide video content into a plurality of video segments; a request receiver configured to receive, from a first content player, a request to stream the video content; an information receiver configured to receive segment playing information from a second content player; an advertisement generator configured to generate an advertisement and playing information regarding the advertisement based on the segment playing information; a selector configured to select at least one of the plurality of video segments based on the segment playing information; a sequence information generator configured to generate play sequence information based on the playing information regarding the advertisement and the at least one of the plurality of video segments; a transmitter configured to transmit, to the first content player, the generated play sequence information, the advertisement, and the at least one of the plurality of video segments to be displayed by the first content player; and a synchronizer configured to synchronize the at least one of the plurality of video segments for playing on the first content player with the at least one of the plurality of video segments for playing on the second content player.

In yet another example embodiment, a user device may comprise: a transmitter configured to transmit, to a server, a request to stream video content; a playing information transmitter configured to transmit, to the server, location information of the user device at the time of a time at which the request to stream the video content was transmitted; a receiver configured to receive, from the server, play sequence information based on playing information regarding an advertisement and at least one of a plurality of video segments, the advertisement and the at least one of a plurality of video segments; and an advertisement player configured to sequentially play the advertisement and the at least one of the plurality of video segments.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system in which one or more embodiments of an advertisement scheme may be implemented, in accordance with various embodiments described herein;

FIG. 2 shows an example device by which at least portions of an advertisement scheme may be implemented, in accordance with various embodiments described herein;

FIG. 3 shows an example device by which at least portions of an advertisement scheme may be implemented, in accordance with various embodiments described herein;

FIG. 4 an example processing flow of operations by which at least portions of an advertisement scheme may be implemented, in accordance with various embodiments described herein;

FIG. 5 shows an example embodiment implemented by at least portions of an advertisement scheme, in accordance with various embodiments described herein; and

FIG. 6 shows an illustrative computing embodiment, in which any of the processes and sub-processes of an advertisement scheme may be implemented as computer-readable instructions stored on a computer-readable medium, in accordance with various embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

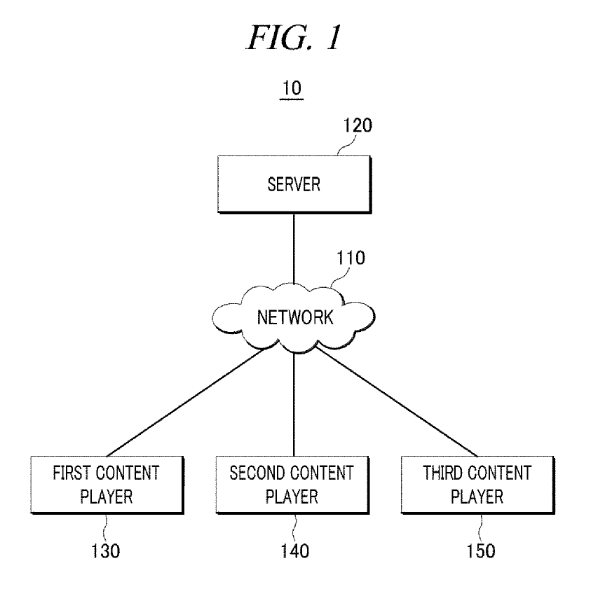

FIG. 1 shows an example system 10 in which one or more embodiments of an advertisement scheme may be implemented, in accordance with various embodiments described herein. As depicted in FIG. 1, system configuration 10 may include, at least, a server 120, and first content player 130, second content player 140, and third content player 150. A server 120 and content players 130, 140 and 150 may be communicatively connected to each other via a network 110.

Network 110 may be a wired or wireless information or telecommunications network. Non-limiting examples of network 110 may include a wired network such as a LAN (Local Area Network), a WAN (Wide Area Network), a VAN (Value Added Network) or the like. Other non-limiting examples of network 110 may include wireless networks such as a mobile radio communication network, including at least one of a 3rd, 4th, or 5th generation mobile telecommunications network (3G), (4G), or (5G); various other mobile telecommunications networks; a cabling telecommunications network; a fiber optics telecommunications network; a satellite network; WiBro (Wireless Broadband Internet); Mobile WiMAX (Worldwide Interoperability for Microwave Access); HSDPA (High Speed Downlink Packet Access) or the like.

Content players 130, 140, 150 may respectively be, for example, but not as a limitation, an IPTV (Internet Protocol Television), a Smart TV (Smart TV), a Connected TV, a notebook computer, a personal computer, a smart phone, a digital camera, a remote controller, a tablet computer, a phablet device, or a personal communication terminal, such as PCS (Personal Communication System), GMS (Global System for Mobile communications), PDC (Personal Digital Cellular), PDA (Personal Digital Assistant), IMT (International Mobile Telecommunication)-2000, CDMA (Code Division Multiple Access)-2000, W-CDMA (W-Code Division Multiple Access) and Wibro (Wireless Broadband Internet) terminal.

Server 120 may be a computing device that is configured or operable to divide video content into a plurality of video segments of equal or disparate lengths based on various criteria, e.g., scene, bit rate, etc. Prior to dividing the plurality of video segments, server 120 may encode the video content into or in real time as the video content is played on any one or more of content players 130, 140, and 150. Non-limiting examples of the length of the divided video segments may include video clips that range from 1 second to 15 seconds.

Also, server 120 may number each of the plurality of video segments sequentially, in the order in which they should be played, and store the assigned number and a length of the video segment as metadata corresponding to the respective video segment.

In a non-limiting example, server 120 may also be configured or operable to receive, from first content player 130, a request to stream the video content to first content player 130 as well as location information of first content player 130 when the request to stream the video content was provided. As an example of the timing for providing the request, a user input to play the video content received by first content player 130 may be time-stamped and transmitted to server 120.

As a non-limiting example of the location information that may accompany the request to server 120, the location information may be determined by the Global Positioning System (GPS), that is, a space-based satellite navigation system and may include location information in GPS coordinates. Another example may be the longitude and latitude of a place. For instance, the position of Lake Maracaibo in Venezuela may be expressed approximately in the WGS84 coordinate system as the location 9.80° N (latitude), 71.56° W (longitude), or 9.80° N 71.56° W.

Upon receiving the request to stream the video content to first content player 130, server 120 may request other content players that may be located near first content player 130 (e.g. content players within 10 meters from first content player 130), for their respective location information and segment playing information upon receiving the request to stream the video content. That is, content player 140, one of the above other content players, may transmit its segment playing information to server 120, in response to the request.

In response to the request, second content player 140, one of the other content players playing the requested video content, may transmit its segment playing information to server 120. That is, segment playing information may include playing points of the content players playing the same requested video content but not necessarily synchronous with each other.

Server 120 may be further configured or operable to compare the respective playing time of the content players located near the requesting content player 130 and to select, from among the nearby content players, a content player that plays the most recent video segment as second content player 140, based on the received segment playing information.

For example, if first content player 130 is located at 9.80° N 71.56° W, and if two other content players playing the same content are located within a predefined distance, e.g., 10 meters, from first content player 130, server 120 may store the content playing information so that server 120 may identify which content players are playing the same content, and further server 120 may identify the location of the nearby content players based on the respective GPS location information. That is, if a player of the two is playing 00:05 of video segment #5, while the other player is playing 00:03 of video segment #6, because video segment #6 is to be played after video segment #5, the other player playing 00:03 of video segment #6 may be determined as a content player playing the most recent video segment. Thus, server 120 may select the other player as second content player 140.

After server 120 receives the segment playing information from second content player 140, server 120 may adjust an existing advertisement that may be stored on the server and playing information regarding the advertisement, based on the segment playing information and duration of the video segment in metadata. An adjusted length of the advertisement may be determined based on a remaining time measured from the time corresponding to video segment when the request to stream the video content was provided to an end point of video segment. Further, the playing information regarding the advertisement may include information of the length of the advertisement.

For example, if server 120 divides video content into a plurality of video segments of 10 seconds to be stored in server 120 and the playing time in a video segment at the time of the request to stream is 00:03, server 120 may identify the remaining time (e.g. 7 seconds) to an end point of the video segment based on the received segment playing information and metadata storing the length of the video segment, and adjust an existing advertisement to have a length of 7 seconds.

Server 120 may select one or more video segments to be played after the generated advertisement. For example, if segment playing information from second content player 140 indicates that second content player 140 is playing a certain video segment at the time of the request for streaming of first content player 130, server 120 may determine that first content player 130 starts playing a immediately next video segment after the certain video segment. Further, server 120 may generate play sequence information which may indicate that first content player 130 plays the advertisement and the immediately next video segment in order.

After server 120 selects the first video segment to be played in first content player 130 and generates play sequence information, server 120 may transmit, to first content player 130, the generated play sequence information, the advertisement, and the first video segment to be played, e.g. video segment #7 (and more video segments). Based on the received play sequence information, first content player 130 may start playing the advertisement, after which first content player 130 may play the first video segment, e.g. video segment #7.

As a result, at the very instant of when first content player 130 plays the first video segment (video segment #7), second content player 130 may start playing the video segment #7. Through this process, first content player 130 may synchronize with second content player 140.

Thus, FIG. 1 shows an example system 10 in which one or more embodiments of an advertisement inserting scheme may be implemented, in accordance with various embodiments described herein.

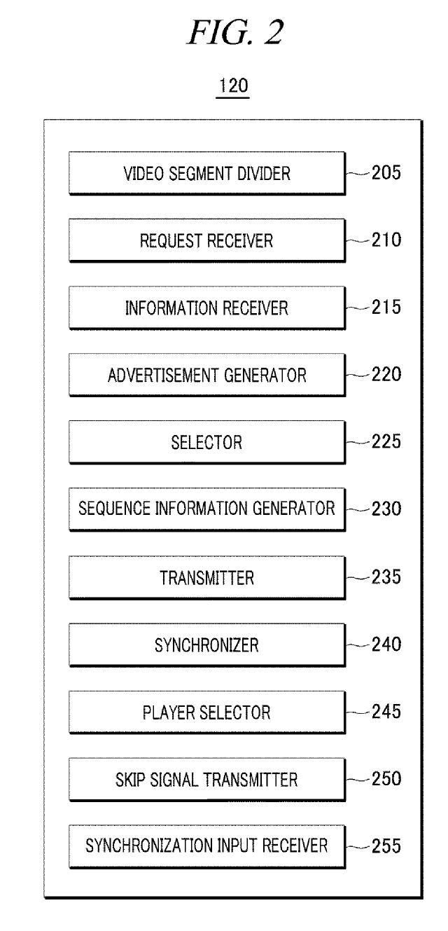

FIG. 2 shows an example device by which at least portions of an advertisement inserting scheme may be implemented, in accordance with various embodiments described herein. As described herein, server 120 may be implemented as software, hardware, firmware, or combinations thereof. For example, as depicted in FIG. 2, server 120 may include a video segment divider 205 configured to divide video content into a plurality of video segments, a request receiver 210 configured to receive, from a first content player, a request to stream the video content, an information receiver 215 configured to receive segment playing information from a second content player, an advertisement generator 220 configured to generate an advertisement and playing information regarding the advertisement based on the segment playing information, a selector 225 configured to select at least one of the plurality of video segments based on the segment playing information, a sequence information generator 230 configured to generate play sequence information based on the playing information regarding the advertisement and the at least one of the plurality of video segments, a transmitter 235 configured to transmit, to the first content player, the generated play sequence information, the advertisement, and the at least one of the plurality of video segments to be displayed by the first content player, and a synchronizer 240 configured to synchronize the at least one of the plurality of video segments for playing on the first content player with the at least one of the plurality of video segments for playing on the second content player.

In some embodiments, video segment divider 205 may be configured to divide video content into a plurality of video segments of equal or disparate lengths. Non-limiting examples of the length of the divided video segments may include video clips that range from 1 second to 30 seconds.

Also, video segment divider 205 may number each of the plurality of video segments sequentially, in the order in which they should be played when the input to play the plurality of video segments is received, and store the assigned number and a length of the video segment as metadata corresponding to the respective video segment.

Request receiver 210 may be configured to receive, from first content player 130, a request to stream the video content to first content player 130, as well as location information of first content player 130 when the request to stream the video content was provided. As an example of the timing for receiving the request, request receiver 210 may receive a user input to play the video content received by first content player 130 that may be time-stamped, by receiving a query through short-range communication protocol.

Information receiver 215 may receive location information and segment playing information of other content players that may be located near first content player 130 (e.g. content players within 10 meters from first content player 130) after requesting the other content players for such location information. Further, information receiver 215 may receive network status information of the other content players that may include information of a time period for which at least one other proximately located content player may not play the video segment due to network problem.

Player selector 245 may be configured to select or identify a content player that has played or is playing the most recent video segment that is proximately located to the first content player 130 as the second content player 140. The selection or identification may be based on the received information regarding the first content player 130, after information receiver 215 has received location information and segment playing information of other content players proximately located to first content player 130. That is, information receiver 215 may receive location information and segment playing information of second content player 140 that played or is playing the most recent video segment.

Advertisement generator 220 may generate an advertisement suitable for playing on the selected content player by adjusting an existing advertisement that may be stored in server 120. That is, advertisement generator 220 may determine an adjusted length of the advertisement based on a remaining time measured from the time corresponding to the most recent video segment when the request to stream the video content was provided to an end point of the most recent video segment.

Alternatively, advertisement generator 220 may determine an adjusted length of the advertisement based on the remaining time and a delay time measured, based on network status information. For example, if the remaining playing time in a video segment is 7 seconds and the delay time caused by network latency is 5 seconds, advertisement generator 220 may adjust an existing advertisement to a playing time of 12 seconds.

Further still, advertisement generator 220 may determine an adjusted length of the advertisement based on the remaining time and a length of a video segment to be played after the most recent video segment. For example, if the remaining time to finish playing the corresponding video segment is 7 seconds and the length of the video segment to be played after the most recent video segment is 8 seconds, advertisement generator 220 may adjust the playing length of an existing advertisement to 15 seconds.

Selector 225 may be configured to select one or more video segments to be played after the generated advertisement. For example, if segment playing information from second content player 140 indicates that second content player 140 is playing a certain video segment at the time of the request for streaming of first content player 130, selector 225 may determine that first content player 130 starts playing a immediately next video segment after the certain video segment.

Sequence information generator 230 may be configured to generate play sequence information based on the playing information regarding the advertisement and the selected one or more video segments. For example, sequence information generator 230 may determine a playing sequence, such as “the advertisement, the video segment #7, the video segment #8 . . . . ”

Transmitter 235 may be configured to transmit, to first content player 130, the generated play sequence information, the advertisement, and the first video segment to be played, e.g. video segment #7 (and more video segments). Then, synchronizer 240 may be configured to synchronize the first video segment for playing on the first content player 130 with the at least one of the plurality of video segments for playing on the second content player 140.

Skip signal transmitter 250 may be configured to transmit, to the first content player 130, an authorization signal that provides authorization to skip the advertisement at the instant time of the end point of the remaining time, in case that advertisement generator 220 generates the advertisement to be played longer than the remaining time. If the first content player 130 receives an input to skip the advertisement while playing after the end point of the remaining time, then the first content player 130 may start playing the next video segment upon skipping of the advertisement.

Synchronization input receiver 255 may be configured to receive, from third content player 150 located around first content player 130, an input to synchronize with the second content player 140.

Thus, FIG. 2 shows an example device by which at least portions of an advertisement inserting scheme may be implemented, in accordance with various embodiments described herein.

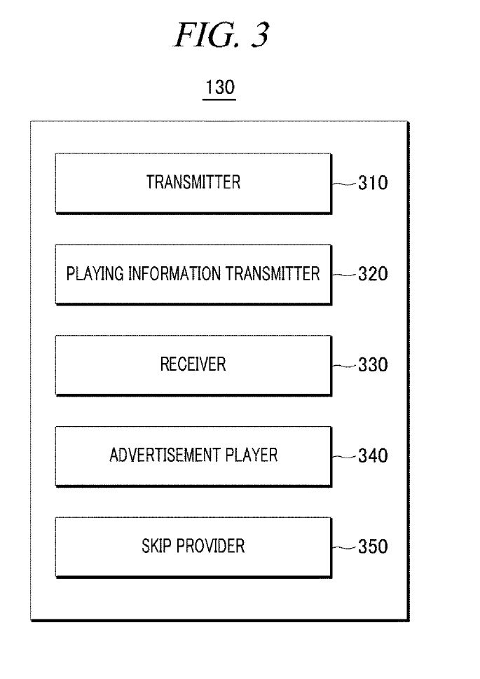

FIG. 3 shows an example device by which at least portions of an advertisement inserting scheme may be implemented, in accordance with various embodiments described herein. As depicted in FIG. 3, first content player 130 may be implemented as software, hardware, firmware, or combinations thereof. First content player 130 may include a transmitter configured to transmit, to a server, a request to stream video content; a playing information transmitter configured to transmit, to the server, location information of the user device at the time of a time at which the request to stream the video content was transmitted; a receiver configured to receive, from the server, play sequence information based on playing information regarding an advertisement and at least one of a plurality of video segments, the advertisement and the at least one of a plurality of video segments; and an advertisement player configured to sequentially play the advertisement and the at least one of the plurality of video segments.

Transmitter 310 may be configured to transmit, to server 120, a request to stream video content. That is, transmitter 310 may transmit a time-stamped user input and the request for streaming to server 120.

Playing information transmitter 320 may be configured to transmit, to server 120, location information of the user device at the time of a time at which the request to stream the video content was transmitted. The location information may be determined by the Global Positioning System (GPS) or some other signal-based navigation system.

Receiver 330 may be configured to receive, from server 120, play sequence information based on playing information regarding an advertisement; and at least one of a plurality of video segments, and the advertisement.

Advertisement player 340 may be configured to sequentially play the advertisement and the at least one of the plurality of video segments.

Skip provider 350 may be a UI-activated component configured to enable the advertisement to be skipped in favor of watching one or more of the video segments.

Thus, FIG. 3 shows an example device by which at least portions of an advertisement inserting scheme may be implemented, in accordance with various embodiments described herein.

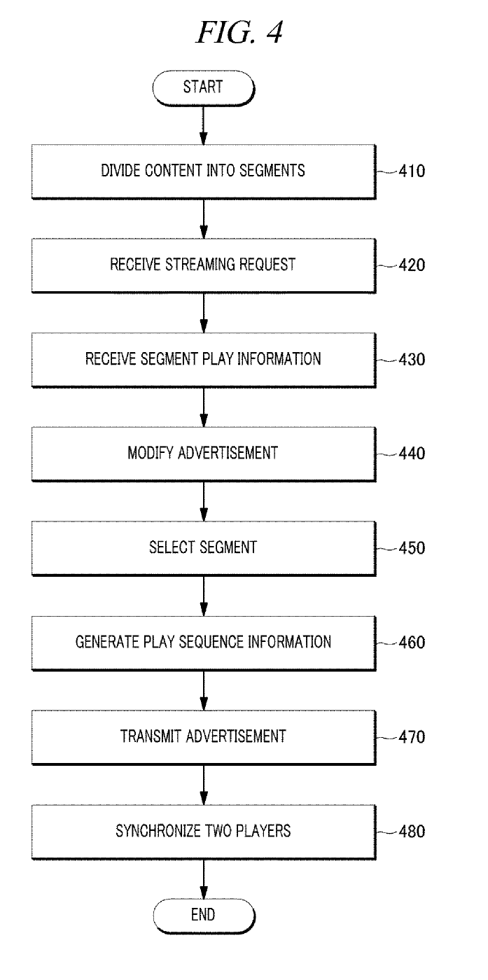

FIG. 4 an example processing flow of operations by which at least portions of an advertisement scheme may be implemented, in accordance with various embodiments described herein. The operations of processing flow 400 may be implemented in system configuration 10 including network 110, server 120, and content players 130, 140, and 150, as illustrated in FIG. 1.

Processing flow 400 may include one or more operations, actions, or functions as illustrated by one or more blocks 410, 420, 430, 440, 450, 460, 470 and/or 480. Although illustrated as discrete blocks, various blocks may be divided into additional blocks, combined into fewer blocks, or eliminated, depending on the desired implementation. Processing may begin at block 410.

Block 410 (Divide Content Into Segments) may refer to server 120 dividing video content into a plurality of video segments of equal or disparate lengths based on various criteria, e.g., scenes, bit rate, etc. Prior to dividing the plurality of video segments, server 120 may encode the video content into or in real time as the video content is played on any one or more of content players 130, 140, and 150. Processing may proceed from block 410 to block 420.

Block 420 (Receive Streaming Request) may refer to server 120 receiving, from first content player 130, a request to stream the video content to first content player 130, as well as location information of first content player 130 when the request to stream the video content was provided. Processing may proceed from block 420 to block 430.

Block 430 (Receive Segment Play Information) may refer to server 120 receiving location information and segment playing information of other content players that may be proximately located to first content player 130 (e.g. content players within 10 meters from first content player 130), after requesting the other content players for such location information.

Server 120 may select or identify a content player that has played or is playing the most recent video segment while proximately located to first content player 130 as the second content player 140. The selection or identification may be based on the received information regarding the first content player 130, after server 120 receives location information and segment playing information of other content players that are proximately located to first content player 130. That is, server 120 may receive location information and segment playing information of second content player 140 that has played or is playing the most recent video segment. Processing may proceed from block 430 to block 440.

Block 440 (Modify Advertisement) may refer to server 120 adjusting the playing length, e.g., playing time, of an existing advertisement that may be stored on the server 120 based on the segment playing information and the duration of the video segment, as indicated in the corresponding metadata stored in server 120. An adjusted playing length of the advertisement may be determined based on a remaining time measured from the time corresponding to video segment when the request to stream the video content was provided to an end point of video segment. Processing may proceed from block 440 to block 450.

Block 450 (Select Segment) may refer to server 120 selecting one or more video segments to be played after the generated advertisement. For example, if segment playing information from second content player 140 indicates that second content player 140 is playing a specific video segment (e.g., #7) at the time of the request for streaming of first content player 130, server 120 may determine that first content player 130 should start playing a next video segment (e.g., #8) immediately after the specific video segment (e.g., #7) is played. Processing may proceed from block 450 to block 460.

Block 460 (Generate Play Sequence Information) may refer to server 120 generating play sequence information that may indicate that first content player 130 is sequentially playing the advertisement and the next video segment (e.g. #8). Processing may proceed from block 460 to block 470.

Block 470 (Transmit Advertisement) may refer to server 120 transmitting, to first content player 130, the generated play sequence information, the advertisement, and the first video segment to be played. Based on the received play sequence information, first content player 130 may start playing the advertisement, after which first content player 130 may play the first video segment. Processing may proceed from block 470 to block 480.

Block 480 (Synchronize Two Players) may refer to server 120 synchronizing first content player 130 and second content player 140 by rendering both players to simultaneously play the same video segment.

Thus, FIG. 4 shows an example processing flow 400 of operations by which at least portions of a narrative generating scheme may be implemented, in accordance with various embodiments described herein.

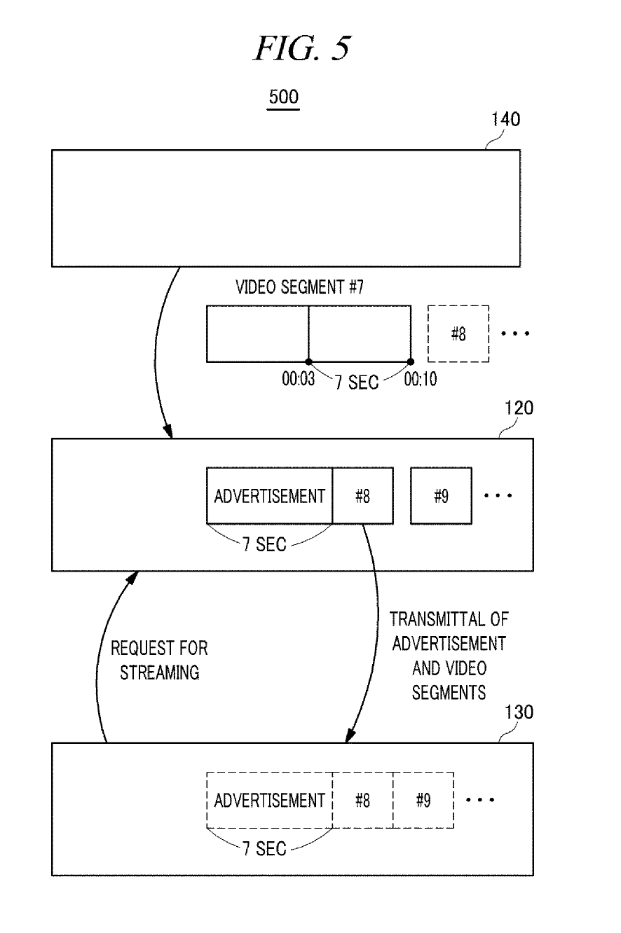

FIG. 5 shows an example embodiment 500 implemented by at least portions of an advertisement scheme, in accordance with various embodiments described herein. As depicted in FIG. 5, first content player 130 may transmit, to server 120, a request to stream the video content to first content player 130 as well as location information of first content player 130. Immediately upon receipt of the request, server 120 may request other content players located near first content player 130 for their respective location information and segment playing information. Thus, second content player 140, one of the above other content players, may transmit its segment playing information to server 120, in response to the request.

FIG. 5 shows an example by which second content player 130 may play 00:03 of 10 second-long video segment #7 at the time of the request. Based on the segment playing information, server 120 may measure the remaining time to the end point of the video segment #7 that may be 7 seconds by receiving, through short range communication protocol, a query including the playing time and calculating the difference between the time at the time of the request and the end point. Sever 120 may generate the advertisement of 7 second duration either by adjusting the playing length of an existing advertisement or by selecting a ready-made advertisement having a playing duration of 7 seconds from the advertisement database that stores advertisements of various lengths.

Further, server 120 may select one or more video segments to be played after the generated advertisement, e.g., video segment #8, #9, . . . . Then, server 120 may generate play sequence information such as “Advertisement, #8, #9, . . . ” and transmit, to first content player 130, the generated advertisement, video segments to be played after the generated advertisement, and the play sequence information.

After first content player 130 plays the advertisement and second content player 140 plays the video segment #7, server 120 may synchronize both players, that is, both players may simultaneously start playing the video segment #8.

Thus, FIG. 5 shows an example embodiment 500 implemented by at least portions of an advertisement scheme, in accordance with various embodiments described herein.

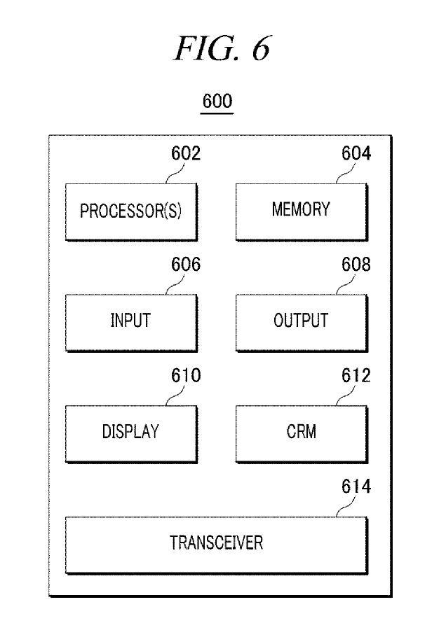

FIG. 6 shows an illustrative computing embodiment, in which any of the processes and sub-processes of an advertisement scheme may be implemented as computer-readable instructions stored on a computer-readable medium, in accordance with various embodiments described herein. The computer-readable instructions may, for example, be executed by a processor of a device, as referenced herein, having a network element and/or any other device corresponding thereto, particularly as applicable to the applications and/or programs described above corresponding to the configuration 10 for transactional permissions.

In a very basic configuration, a computing device 600 may typically include, at least, one or more processors 602, a system memory 604, one or more input components 606, one or more output components 608, a display component 610, a computer-readable medium 612, and a transceiver 614.

Processor 602 may refer to, e.g., a microprocessor, a microcontroller, a digital signal processor, or any combination thereof.

Memory 604 may refer to, e.g., a volatile memory, non-volatile memory, or any combination thereof. Memory 604 may store, therein, an operating system, an application, and/or program data. That is, memory 604 may store executable instructions to implement any of the functions or operations described above and, therefore, memory 604 may be regarded as a computer-readable medium.

Input component 606 may refer to a built-in or communicatively coupled keyboard, touch screen, or telecommunication device. Alternatively, input component 606 may include a microphone that is configured, in cooperation with a voice-recognition program that may be stored in memory 604, to receive voice commands from a user of computing device 600. Further, input component 606, if not built-in to computing device 600, may be communicatively coupled thereto via short-range communication protocols including, but not limitation, radio frequency or Bluetooth.

Output component 608 may refer to a component or module, built-in or removable from computing device 600, that is configured to output commands and data to an external device.

Display component 610 may refer to, e.g., a solid state display that may have touch input capabilities. That is, display component 610 may include capabilities that may be shared with or replace those of input component 606.

Computer-readable medium 612 may refer to a separable machine readable medium that is configured to store one or more programs that embody any of the functions or operations described above. That is, computer-readable medium 612, which may be received into or otherwise connected to a drive component of computing device 600, may store executable instructions to implement any of the functions or operations described above. These instructions may be complimentary or otherwise independent of those stored by memory 604.

Transceiver 614 may refer to a network communication link for computing device 600, configured as a wired network or direct-wired connection. Alternatively, transceiver 614 may be configured as a wireless connection, e.g., radio frequency (RE), infrared, Bluetooth, and other wireless protocols.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

Thus, FIG. 6 shows an illustrative computing embodiment, in which any of the processes and sub-processes of an advertisement scheme may be implemented as computer-readable instructions stored on a computer-readable medium, in accordance with various embodiments described herein.

We claim:

1. A method performed under control of a server, comprising:
dividing video content into a plurality of video segments;
receiving, from a first content player, a request to stream the video content;
receiving segment playing information from a second content player;
generating an advertisement and playing information regarding the advertisement based on the segment playing information;
selecting at least one of the plurality of video segments based on the segment playing information;
generating play sequence information based on the playing information regarding the advertisement and the at least one of the plurality of video segments;
transmitting, to the first content player, the generated play sequence information, the advertisement, and the at least one of the plurality of video segments; and
synchronizing the at least one of the plurality of video segments for playing on the first content player with the at least one of the plurality of video segments for playing on the second content player.

2. The method of claim 1, further comprising:
receiving information regarding the first content player; and
selecting a content player playing the video content located around the first content player as the second content player, based on the received information regarding the first content player.

3. The method of claim 2, wherein the information regarding the first content player includes location information at the time of a time at which the request to stream the video content was provided.

4. The method of claim 3, wherein the segment playing information includes a time corresponding to a first segment that is played at the time at which the request to stream the video content was provided.

5. The method of claim 4, wherein the playing information of the advertisement includes a length of the advertisement that is based on a remaining time measured from the time corresponding to the first segment when the request to stream the video content was provided to an end point of the first segment.

6. The method of claim 5, wherein the length of the advertisement is further based on a delay time measured from network status information.

7. The method of claim 5, wherein the length of the advertisement is based on a length of a second segment to be played after the first segment.

8. The method of claim 1, further comprising:
transmitting, to the first content player, an authorization signal that provides authorization to skip the advertisement.

9. The method of claim 1, further comprising:
receiving, from a third content player, an input to synchronize with the second content player; and
transmitting, to the third content player, the generated play sequence information, the advertisement, and the at least one of the plurality of video segments.

10. A server, comprising:
a video segment divider configured to divide video content into a plurality of video segments;
a request receiver configured to receive, from a first content player, a request to stream the video content;
an information receiver configured to receive segment playing information from a second content player;
an advertisement generator configured to generate an advertisement and playing information regarding the advertisement based on the segment playing information;
a selector configured to select at least one of the plurality of video segments based on the segment playing information;
a sequence information generator configured to generate play sequence information based on the playing information regarding the advertisement and the at least one of the plurality of video segments;
a transmitter configured to transmit, to the first content player, the generated play sequence information, the advertisement, and the at least one of the plurality of video segments to be displayed by the first content player; and
a synchronizer configured to synchronize the at least one of the plurality of video segments for playing on the first content player with the at least one of the plurality of video segments for playing on the second content player.

11. The server of claim 10,
wherein the request receiver is further configured to receive information regarding the first content player, and
wherein the server further comprises:
a player selector configured to select a content player playing the video content located around the first content player as the second content player, based on the received information regarding the first content player.

12. The server of claim 11, wherein the information regarding the first content player includes location information at the time of a time at which the request to stream the video content was provided.

13. The server of claim 12, wherein the segment playing information includes a time corresponding to a first segment that is played at the time at which the request to stream the video content was provided.

14. The server of claim 13, wherein the playing information of the advertisement includes a length of the advertisement that is determined based on a remaining time measured from the time corresponding to the first segment when the request to stream the video content was provided to an end point of the first segment.

15. The server of claim 14, wherein the length of the advertisement is further based on a delay time measured from network status information.

16. The server of claim 14, wherein the length of the advertisement is based on a length of a second segment to be played after the first segment.

17. The server of claim 10, further comprising:
a skip signal transmitter configured to transmit, to the first content player, an authorization signal that provides authorization to skip the advertisement.

18. The server of claim 10, further comprising:
a synchronization input receiver configured to receive, from a third content player, an input to synchronize with the second content player, and
wherein the transmitter is further configured to transmit, to the third content player, the generated play sequence information, the advertisement, and the at least one of the plurality of video segments.

19. A user device, comprising:
a transmitter configured to transmit, to a server, a request to stream video content;
a playing information transmitter configured to transmit, to the server, location information of the user device at the time of a time at which the request to stream the video content was transmitted;
a receiver configured to receive, from the server, play sequence information based on playing information regarding an advertisement and at least one of a plurality of video segments, the advertisement and the at least one of a plurality of video segments; and
an advertisement player configured to sequentially play the advertisement and the at least one of the plurality of video segments.

20. The user device of claim 19, further comprising:
a skip provider configured to display a skip button to skip the advertisement while playing.
